(19) United States
(12) Patent Application Publication
(10) Pub. No.: US 2013/0055778 A1
(43) Pub. Date: Mar. 7, 2013

(54) METHOD FOR FORMING, BY MEANS OF A HYDROFORMING PROCESS, A TUBULAR ELEMENT AS WELL AS A DEVICE SUITABLE FOR CARRYING OUT SUCH A METHOD, AND A TUBULAR ELEMENT

(71) Applicant: Mathieu Ernest Antonius Maria Slangen, Maastricht (NL)

(72) Inventor: Mathieu Ernest Antonius Maria Slangen, Maastricht (NL)

(73) Assignee: KISS ENGINEERING B.V., Echt (NL)

(21) Appl. No.: 13/582,248

(22) PCT Filed: Mar. 2, 2011
(86) PCT No.: PCT/IB2011/050882

§ 371 Date: Nov. 14, 2012

(30) Foreign Application Priority Data
Mar. 3, 2010 (NL) 2004330

(51) Int. Cl. B21D 26/033; F16L 9/00; B29C 49/46

(52) U.S. Cl. 72/61; 264/523; 425/522; 138/177

(57) ABSTRACT

A tubular element extending along a central axis, which element comprises at least one locally deformed part, is formed by means of a hydroforming process. A tube is positioned in a die comprising at least two die parts. Subsequently a hydraulic pressure is applied to the inside of the tube, as a result of which at least a part of the tube present in a cavity defined by the die parts is locally deformed. The die parts defining the cavity are axially moved toward each other upon formation of the locally deformed parts, thereby reducing the dimension of the cavity.

A method for forming, by means of a hydroforming process, a tubular element as well as a device suitable for carrying out such a method, and a tubular element

### DESCRIPTION

The invention relates to a method for forming, by means of a hydroforming process, a tubular element extending along a central axis, which element comprises at least one locally deformed part having at least one dimension in radial direction that is different from a dimension in radial direction of the tubular element, wherein a tube is positioned in a die comprising at least two die parts and subsequently a hydraulic pressure is applied to the inside of the tube, as a result of which at least a part of the tube present in a cavity defined by the die parts is locally deformed, wherein the die parts defining the cavity are axially moved toward each other upon formation of the locally deformed part so as to reduce the dimension of the cavity.

The invention also relates to a device suitable for carrying out such a method as well as to a tubular element formed by means of such a method.

With such a method and device, which are known from DE 196 22 372 A1, walls of a tube are deformed at the location of the cavity by applying a hydraulic pressure to the inside of the tube. This process is called hydroforming. At the same time, the die parts are moved toward each other, as a result of which the material of the tube walls can relatively easily be pressed into the cavity, whilst practically no supply of material to the cavity from parts of the tube adjacent to the cavity will take place.

Said method is suitable for use in those cases in which the locally deformed apart extends at substantially the same distance from the central axis of the tube over the entire circumference of the tube. If such is not the case, compressing will take place at those locations where the radial distance is smaller than at other parts upon movement in axial direction toward each other of the die parts, which will lead to uncontrolled and undesirable wrinkle formation.

The object of the invention is to provide a method which makes it possible in a simple manner to deform a part of the tube by means of a hydroforming process whilst preventing wrinkle formation.

This object is accomplished with the method according to the invention in that in said cavity the part to be deformed is deformed along a relatively small length in axial direction over a relatively large distance in radial direction on a first side of the central axis, whilst the part to be deformed is deformed along a relatively great length in axial direction over a relatively small distance in radial direction at least on a second side opposite said first side.

On the first side, the locally deformed part forms a projection which extends along a relatively small length in axial direction and which extends over a relatively large distance in radial direction. The wall thickness of the projection is determined by the original wall thickness of the tube and the length of the tube from which the projection is formed. The wall thickness can be determined by experiment or by calculation.

Subsequently it can be determined, by experiment or by calculation, to what extent and along what axial distance radial deformation of the tubular element must take place so as to obtain a wall thickness in the second side opposite said first side which is substantially equal to the wall thickness of the projection, for example. The maximum radial deformation is in that case determined by the maximum required radius of the final tube.

After the tube has thus been deformed and the locally deformed part has been formed, the inside diameter and the outside diameter of the adjacent part of the tubular element or the entire tubular can be increased, preferably to such an extent that the wall thickness or the radius thereof will be equal to the wall thickness or the radius of the locally deformed part on the second side. In this way it is possible to obtain a tubular element having a substantially constant wall thickness. It is also possible to realise a different required wall thickness distribution over the tubular part and the locally deformed part in this way, starting from a tube having a constant wall thickness, for example.

Upon deformation of the local part, the tube parts adjacent to the cavity need not be moved relative to the die, so that the forces that occur will be significantly smaller and undesirable deformation of the tube parts adjacent to the cavity will be prevented.

By moving the die parts toward each other, tube material is displaced in axial direction, which material will subsequently be available for being displaced in radial direction into the cavity. This results in a wall thickness of the locally deformed part greater than the wall thickness that would have been obtained if no axial displacement had taken place. The use of a predetermined combination of the shape of the cavity and controlled displacement in axial direction makes it possible only to bend the tube wall in the cavity, with practically no change in wall thickness taking place.

It is noted that with a method known from US patent U.S. Pat. No. 7,337,641 B1 the tubular element is locally deformed in radial direction on one side, thereby forming a projection in radial direction. To that end, a tube is placed in an axially extending cylindrical opening of a die. The die is further provided with a radially extending recess, which is connected to the opening. Pistons are movably accommodated in ends of the cylindrical opening, abutting against the tube ends. A fluid is introduced into said tube, and subsequently said fluid is pressurized. The resulting hydraulic pressure presses the tube against the die wall and part of the tube wall is pressed into the recess. Upon deformation in radial direction of the tube, the pistons are moved toward each other, thus simultaneously causing the tube to compress in axial direction.

Thus, a tubular element having a locally deformed part which comprises a projection on one side of the central axis is formed from a tube.

Upon movement toward each other of the tube ends, the entire tube must be moved relative to the die, so that relatively large frictional forces between the inner walls of the die and the outer wall of the tube need to be overcome.

One embodiment of the method according to the invention is characterised in that the entire part to be locally deformed has a substantially constant wall thickness during the formation thereof, which wall thickness is preferably the same as the wall thickness of the tube.

In this way a tubular element comprising a locally deformed part having a uniform wall thickness is obtained.

Another embodiment of the method according to the invention is characterised in that, after the locally deformed part has been formed, the tubular element is deformed to the same external dimension as the external dimension of the second side of the locally deformed part.

The tubular element that is eventually formed thus has a uniform, constant dimension on the second side. Depending on the extent of axial displacement during the formation of the locally deformed part, the tubular element, which originally has the same external diameter as the locally deformed part, may have a wall thickness which is smaller than that of the locally deformed part after the formation of the locally deformed part. As a result, the locally deformed part will be stronger than the adjacent part.

Yet another embodiment of the method according to the invention is characterised in that, after the tubular element comprising the locally deformed part has been formed from the tube, at least one part of the tubular element adjacent to the locally deformed part is deformed, resulting in an increased dimension at least in radial direction of said part.

Said increase can be realised by means of a hydroforming process, for example. Increasing the dimension in radial direction of the entire tubular element or only of a part of the tubular element adjacent to the locally deformed part will result in an increased circumferential dimension and a decreased wall thickness of the tubular element. As a result, a required difference between the wall thickness of the locally deformed part and the wall thickness of the tubular element can be obtained and, starting from a tube having a constant wall thickness in axial direction, a tubular element comprising a locally deformed part, each having any desired wall thickness, can be realised.

Another embodiment of the method according to the invention is characterised in that the die comprises a number of units each comprising of two sets of die parts, which sets of die parts of each unit of two sets of die parts are axially moved toward each other during the formation of the locally deformed part in the cavity of the die parts in question.

In this way a number of locally deformed parts can be formed simultaneously in a tube, so that a relatively high production rate is realised.

Yet another embodiment of the method according to the invention is characterised in that the units are axially moved relative to each other upon formation of the locally deformed part, whilst a constant spacing is maintained between die parts of two units disposed adjacent to each other.

If three or more units are used, for example, moving the units relative to each other whilst simultaneously maintaining a constant spacing between die parts of two units disposed adjacent to each other, the parts of the tube located between said units will not be deformed but only moved to an extent corresponding to the movements of the die parts.

Yet another embodiment of the method according to the invention is characterised in that after the tubular part comprising the locally deformed part has been formed, the die parts in the die are exchanged for die parts that define a larger cavity, whereupon the locally deformed part is positioned in the larger cavity and subsequently a hydraulic pressure is applied, resulting in further deformation of the locally deformed part in the larger cavity, wherein at least two die parts are axially moved toward each other during said further deformation of the locally deformed part.

In this way the required shape of the locally deformed part is obtained in steps. During the formation of the locally deformed part, the die parts can be axially moved over a distance of, for example, 3-5 mm relative to each other, whereupon the die parts are exchanged for other die parts. As a result of the relatively small movement, the distance between the die parts positioned opposite each other, seen in axial direction, is small as well, so that the risk of the tube being pressed into the space between the die parts is prevented in a simple manner.

The invention further relates to a device suitable for carrying out the method according to the invention, which device at least comprises a die defining a cavity as well as means for applying a hydraulic pressure to the inside of a tube to be deformed, which is to be positioned in the die, which die comprises at least two die parts being axially movable toward each other, which die parts define a cavity, wherein on a first side of the central axis the cavity is bounded by a wall which extends along a relatively small length in axial direction and over a relatively large distance in radial direction, whilst on a second side opposite said first side the cavity is bounded by a wall which extends along a relatively great length in axial direction and over a relatively small distance in radial direction.

The die parts are moved toward each other during the formation of the locally deformed part in the tube, whilst the walls of the cavity are preferably so dimensioned and the movement of the die parts is preferably such that the tube wall is only bent, without the wall thickness of the tube at the location of the locally deformed part being changed.

One embodiment of the device according to the invention is characterised in that the die parts are provided with recesses and projections extending in axial direction, with projections of one die part being movably accommodated in recesses of the other die part, and conversely.

The mating projections and recesses make it possible to create a cavity defined by the die parts, the dimension in axial direction of which cavity can be adapted during the deformation process. The spaces present between the projections and the recesses are comparatively limited in size, so that the risk of the tube entering said spaces is small.

Another embodiment of the device according to the invention is characterised in that the die comprises at least two sets of die parts, which sets are axially movable toward each other, each set comprising at least two die parts which are radially movable toward and away from each other.

Thus, a die is provided in which a tube can be placed, which die comprises die parts which are axially movable relative to each other.

Yet another embodiment of the device according to the invention is characterised in that the die comprises a number of units each comprising of two sets of die parts, which sets of die parts of each unit of two sets of die parts are axially movable toward each other.

Using such a die, a number of locally deformed parts can be formed simultaneously in a tube.

Yet another embodiment of the method according to the invention is characterised in that the units are axially movable relative to each other.

As a result, it can be achieved in a simple manner that the parts of the tube located between said units will not be deformed.

Another embodiment of the device according to the invention is characterised in that the die parts are detachably provided in the die, being exchangeable for die parts that define a larger cavity.

As a result, a controlled deformation of the tube to form a tubular element comprising a locally deformed part can be realised in a number of successive steps, during each of which steps the die parts are exchanged.

The invention will now be explained in more detail with reference to the drawing, in which:

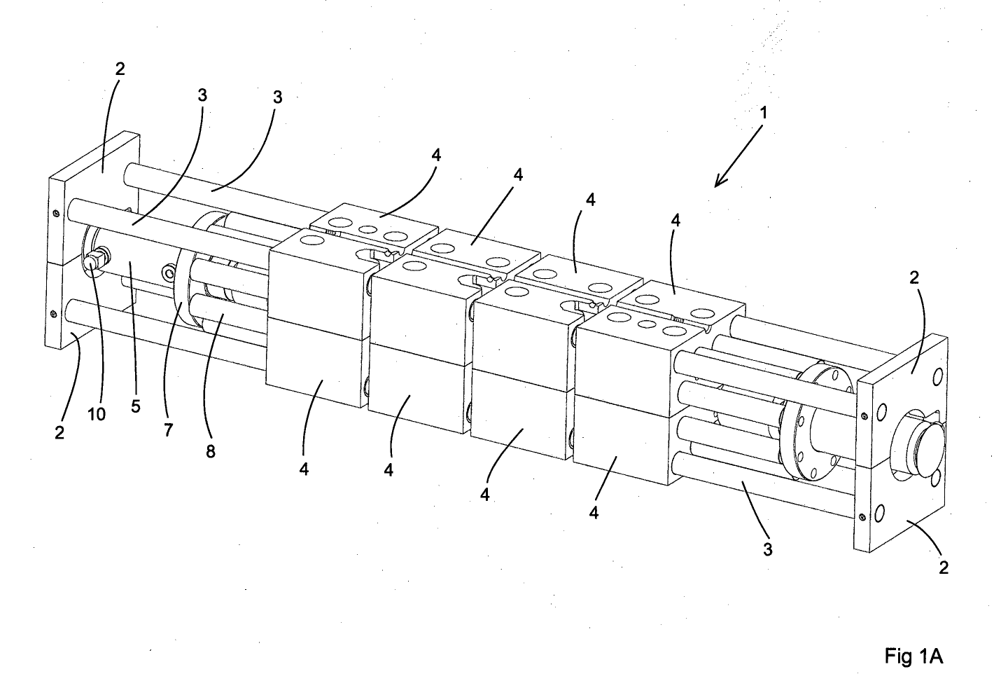

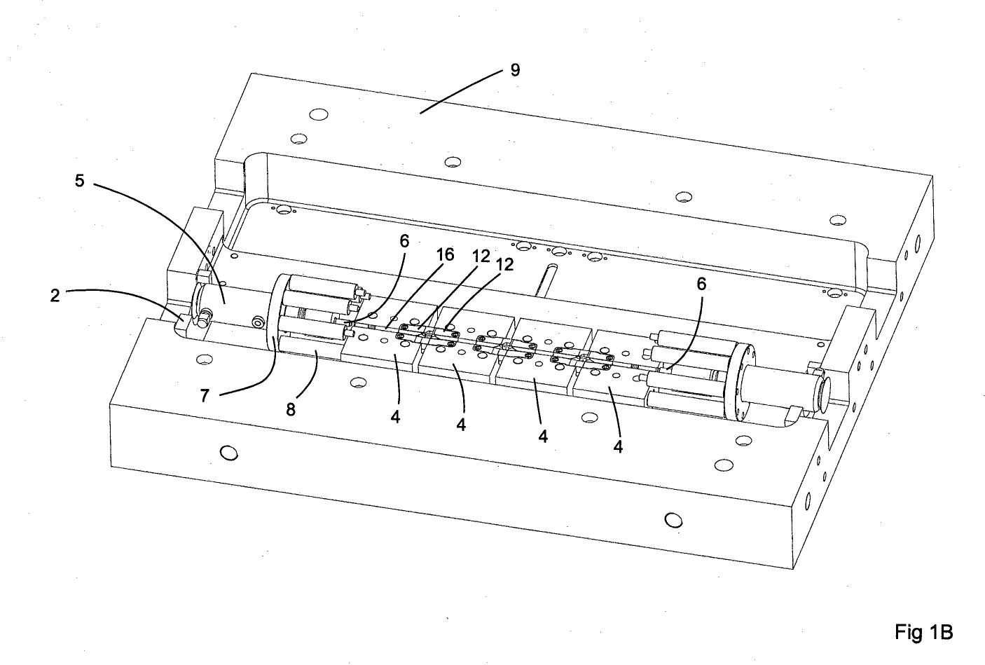

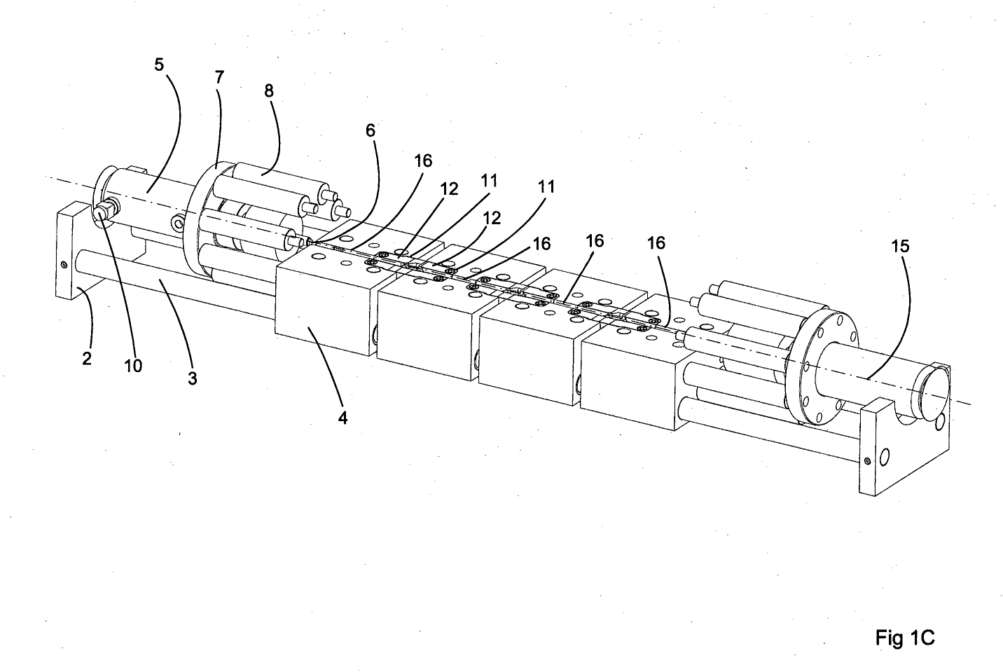

FIGS. 1A, 1B and 1C show a perspective view, a cross-sectional view and a larger-scale cross-sectional view of the device according to the invention;

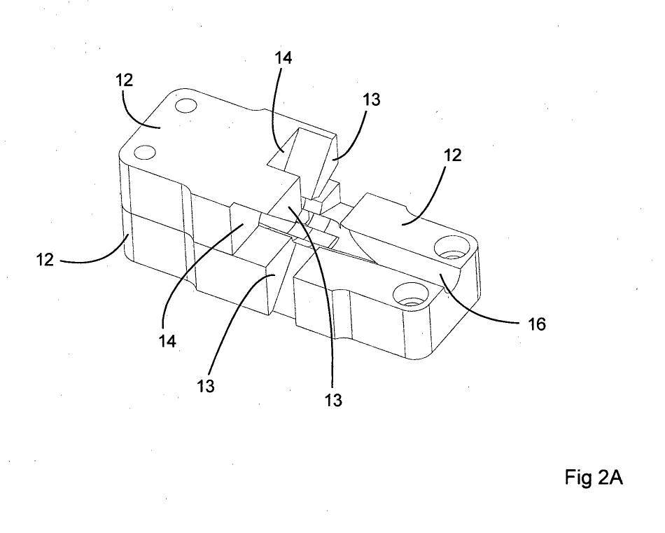

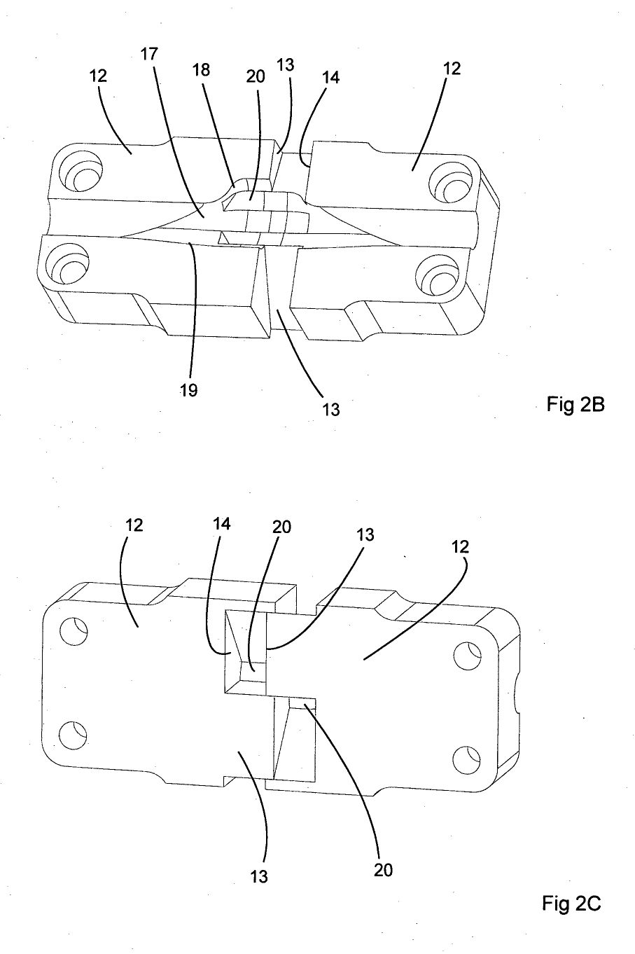

FIGS. 2A, 2B and 2C show a perspective view of three die parts, a perspective front view of two die parts and a perspective rear view of two die parts of the device according to the invention;

FIG. 3 schematically shows the formation of a locally deformed part in a tube;

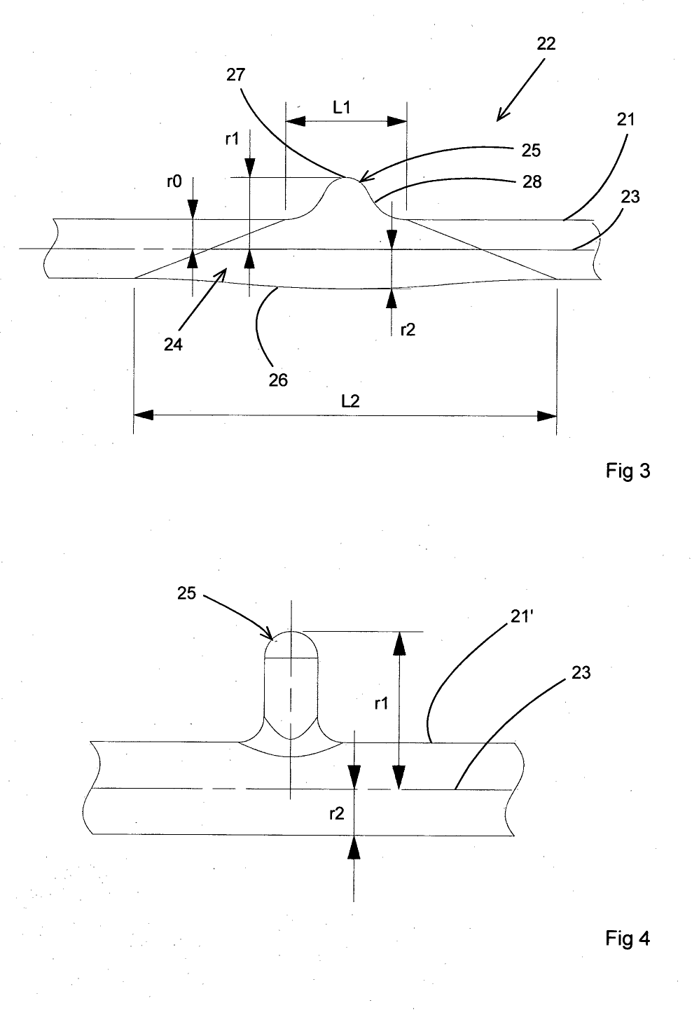

FIG. 4 schematically shows the step of enlarging the diameter of the tube of the tubular element after the step of forming the locally deformed part;

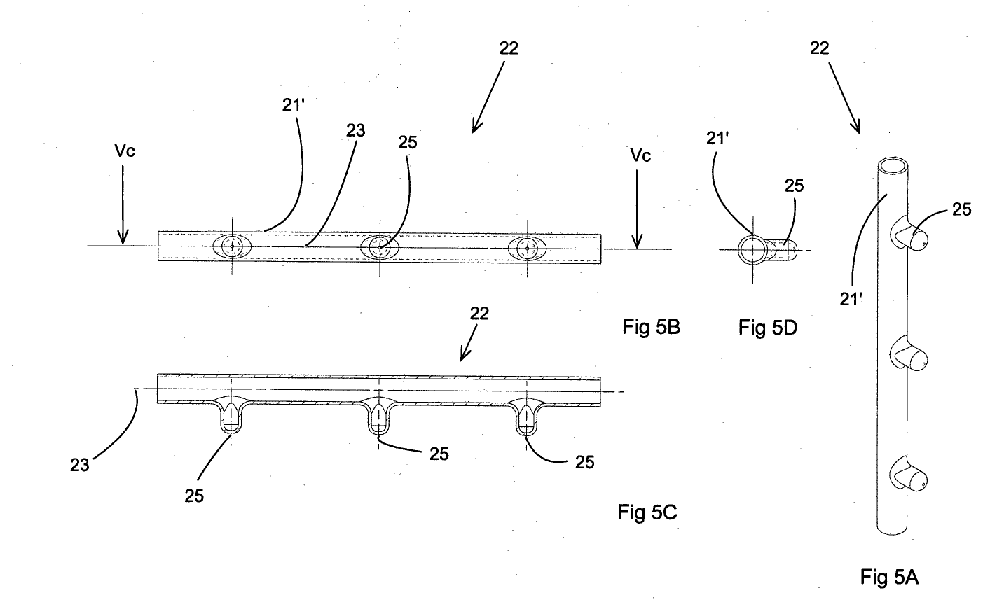

FIGS. 5A-5D show a perspective view, a front view, a top plan view and a side view of a first embodiment of a tubular element according to the invention;

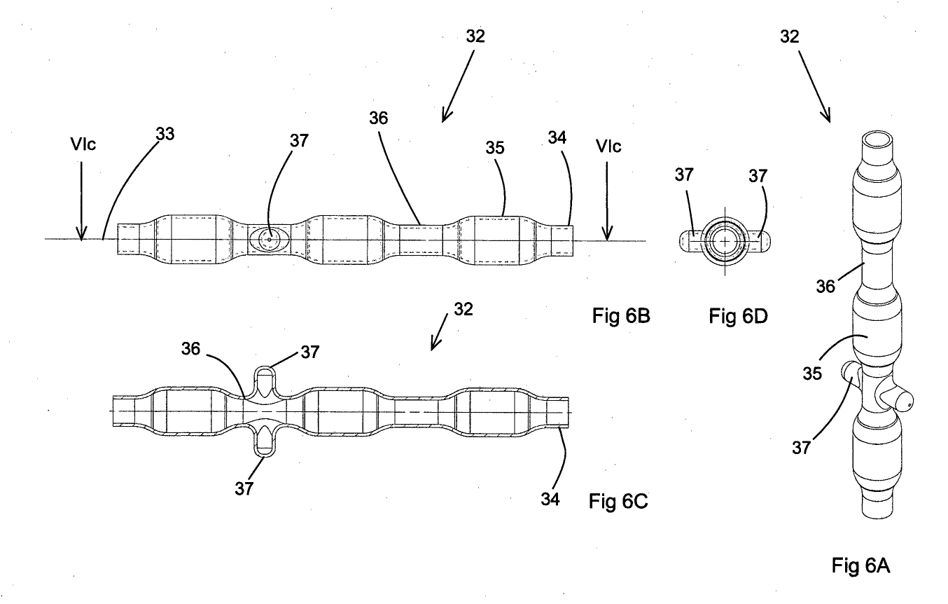

FIGS. 6A-6D show a perspective view, a front view, a top plan view and a side view of a second embodiment of a tubular element according to the invention;

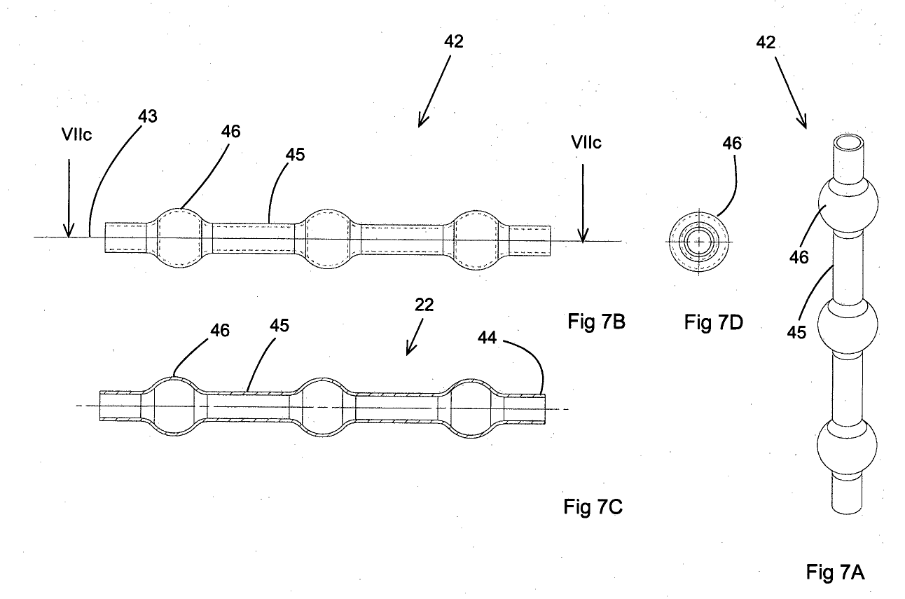

FIGS. 7A-7D show a perspective view, a front view, a top plan view and a side view of a third embodiment of a tubular element according to the invention.

Like parts are indicated by the same numerals in the figures.

FIGS. 1A, 1B and 1C show a perspective view, a cross-sectional view and a larger-scale cross-sectional view, respectively, of a device 1 according to the invention. The device 1 comprises two pairs of frame plates 2 and rods 3 extending from said frame plates 2. The rods 3 abut against outer die blocks 4 on sides remote from the frame plates 2. Disposed between the outer die blocks 4 are inner die blocks 4, which are movable relative to the outer die blocks 4 and relative to each other. The lower frame plates 2 each support a hydraulic cylinder 5, a pin 6 that can be moved by means of the hydraulic cylinder 5 and, on the side remote from the frame plate 2, an annular disc 7 provided with spacers 8, which is supported by the cylinder. At least one pin 6 is hollow, through which pin 6 a hydraulic fluid can be supplied and discharged via a passage 10. The whole is mounted in a base frame 9. The upper frame plates 9 and the four upper die blocks 4 disposed therebetween are vertically movable relative to the lower frame plates 2.

FIG. 1B shows the lower frame plates 2 with the parts disposed therebetween.

The device 1 further comprises hydraulic cylinders (not shown), by means of which opposite frame plates 2 can be moved toward and away from each other for moving the die blocks 4 relative to each other. First the outer die blocks 4 are moved toward each other by the rods 3 abutting against said die blocks. Once the outer die blocks have been moved into contact with the inner die blocks, the inner die blocks 4 are moved toward each other.

As is shown in FIGS. 1B and 1C, each die block 4 is provided with a recess 11, in which a die part 12 is accommodated, which die part mates with a die part 12 accommodated in an adjacent die block 4. The die parts 12 are detachably connected to the die blocks 4 by means of bolts. Each die part 12 is provided with a number of finger-shaped projections 13, which are movably accommodated in recesses 14 of the adjacent die part 12. See FIGS. 2A-2C. The middle two pairs of die blocks 4 are each provided with die parts 12 or on either side thereof. The die blocks 4 and the die parts 12 are further provided with an elongated, tubular recess 16 extending along a central axis 15. Each die part 12 further comprises a recess 17, which is bounded by a wall 18 on a first side of the central axis and by a wall 19 on a second side opposite said first side. The wall 18 is spaced further from the central axis 15 than the wall 19. The length of the wall 18 in axial direction is smaller than that of the wall 19.

Two die parts 12 positioned one above the other form a set of die parts 12. In total, the device 1 comprises three units each comprising of two sets of die parts 12. The recesses 17 of two interlocking sets of die parts 12 form a cavity bounded by the die parts. Prior to the process of hydroforming, the die blocks 4 are moved relative to each other, such that a space 20 is present between the projection 13 of one die part 12 and the recess of the other die part interlocked therewith. Said space 20 has a dimension in axial direction of, for example, 3-5 mm.

The operation of the device 1 is as follows. The tube 21 is positioned in the recess 16 in the lower die blocks 4, whereupon the upper die blocks 4 are placed on top of the lower die blocks 4 and detachably attached thereto. The diameter of the tube 21 and that of the recess 16 are preferably substantially identical.

Then the pins 6 are pressed into the ends of the tube 21 by means of the hydraulic cylinders 5, with the pins 6 sealing said ends. Subsequently, a hydraulic fluid is introduced into the tube 21 via the passage 10 and the hollow pin 6, which fluid is then pressurized. The skilled person will be familiar with the equipment that is needed for this purpose, which will not be explained in more detail herein, therefore.

The fluid pressure causes the wall of the tube 21 to be pressed against the walls of the recesses 16, 17, with the tube 21 being locally deformed in the cavity defined by the recesses 17. At the same time, axial forces are exerted on the frame plates 2, as a result of which the die blocks 4, and consequently the die parts 12, are moved relative to each other. The movement of the various pairs of die blocks 4 is determined in advance in dependence on the required deformations in the cavities.

FIG. 3 is a schematic cross-sectional view of a tubular element 22 formed by means of the device 1. The tubular element 22 comprises the locally deformed part 24 and parts of the tube 21 located on either side thereof. The tube 21 extends along a central axis 23. The locally deformed part 24 has a cylindrical projection 25 on a first side of the central axis 23, which projection extends transversely to the central axis 23. On a second side of the central axis 23 remote from said first side, the locally deformed part 24 comprises an arcuate curved portion 26. Seen in the axial direction of the central axis 23, the cylindrical projection 25 has a length L1 and a height r1−r0, r1 being the radius of the wall 27 that closes the cylinder 28 of the cylindrical projection 25 and r0 being the radius of the tube 21. The cylindrical projection 25 is formed from the material which originally was material of the tube 21. The volume of the material can be determined from the length L1, the height r1−r0 and the wall thicknesses. Combined with the wall thickness of the tube 21, it is possible to determine therefrom the length of the tube 21 from which the projection 25 was formed. Said length is greater than the length L1. To prevent uncontrolled wrinkle formation in the second side of the wall of the tube 21 upon formation of the projection 25, an arcuate curved portion 26 is formed on the second side. If the wall thickness in the curved portion 26 remains substantially constant along the entire curved portion during the formation of the locally deformed part, it is possible to determine the required length L2 and the maximum radius r2 of the curved portion. Furthermore, it is possible to determine the desired curvature for any position in the circumferential direction of the tubular element 22 between the projection 25 and the curve 26, such that there will be practically no change in the wall thickness.

After the formation of the locally deformed parts 24 in the tube 21, the die parts 12 of the device 1 are exchanged for other die parts 12 having recesses which are larger than the recesses 17 Subsequently, the tube 21 with the locally deformed parts 24 formed therein is positioned in the die parts having the larger recesses. Following that, further deformation of the locally deformed parts takes place. The step of exchanging the die parts and the subsequent further deformation of the locally deformed parts by means of a hydroforming process is repeated until the locally deformed parts 24 have the required dimensions. Because of the relatively small deformations that are realised with every next step, the formation of the tube can practically entirely take place by bending the tube material, with the wall thickness of the tube and of the deformed part 21 remaining substantially constant. This is advantageous for various materials.

Since a further small deformation is realised with every next step, a controlled deformation is possible. Moreover, the die parts 12 only need to be moved over a small distance of, for example, 3-5 mm relative to each other with each step, thus avoiding the risk that the wall of the tube 21 will be pressed into the spaces 20 that are present between ends of the finger-shaped projections 13 and ends of the recesses 14.

If desired, the tube 21 and the parts formed thereon can be deformed, using a hydroforming process, to obtain a through tube 21′ having a constant outer diameter 2*r2 (see figure ₄). The wall thickness of the tube 21′ thus obtained will be smaller than the wall thickness of the original tube 21. At the location of the projection 25, the wall thickness will be substantially the same as the original wall thickness of the tube 21. Opposite the projection 25, at the location of the previously formed curve 26, the wall thickness will also be substantially the same as the original wall thickness of the tube 21. The wall thickness gradually decreases in axial direction to the wall thickness of the tube 21′ having the radius r2.

FIGS. 5A-5D are various views of the tubular element 21 that is eventually formed.

FIGS. 6A-6D show another embodiment of a tubular element 32 which comprises a tube 34 extending along a central axis 33, which tube is provided with alternately arranged cylindrical parts 35 and 36, with the parts 35 having a larger diameter than the parts 36. One part 36 is provided with two projections 37 extending transversely to the central axis 33.

FIGS. 7A-7D show another embodiment of a tubular element 42 which comprises a tube 44 extending along a central axis 43, which tube is provided with alternately arranged cylindrical parts 45 and 46. The spherical part 46 has a larger diameter than the cylindrical part 45.

It is also possible to form the tubular element 22 in a single step.

The tubular elements can be made of any deformable material.

1-14. (canceled)

15. A method for forming, by means of a hydroforming process, a tubular element extending along a central axis, which element comprises at least one locally deformed part having at least one dimension in radial direction that is different from a dimension in radial direction of the tubular element, wherein a tube is positioned in a die comprising at least two die parts and subsequently a hydraulic pressure is applied to the inside of the tube, as a result of which at least a part of the tube present in a cavity defined by the die parts is locally deformed, wherein the die parts defining the cavity are axially moved toward each other upon formation of the locally deformed parts so as to make the cavity smaller, characterized in that in said cavity the part to be deformed is deformed along a relatively small length in axial direction over a relatively large distance in radial direction on a first side of the central axis, whilst the part to be deformed is deformed along a relatively great length in axial direction over a relatively small distance in radial direction at least on a second side opposite said first side.

16. A method according to claim 15, characterized in that the entire part to be locally deformed has a substantially constant wall thickness during the formation thereof, which wall thickness is preferably the same as the wall thickness of the tube.

17. A method according to claim 15, characterized in that after the locally deformed part has been formed, the tubular element is deformed to the same external dimension as the external dimension of the second side of the locally deformed part.

18. A method according to claim 15, characterized in that after the tubular element comprising the locally deformed part has been formed from the tube, at least one part of the tubular element adjacent to the locally deformed part is deformed, resulting in an increased dimension at least in radial direction of said part.

19. A method according to claim 15, characterized in that the die comprises a number of units each comprising of two sets of die parts, which sets of die parts of each unit of two sets of die parts are axially moved toward each other during the formation of the locally deformed part in the cavity of the die parts in question.

20. A method according to claim 19, characterized in that the units are axially moved relative to each other upon formation of the locally deformed part, whilst a constant spacing is maintained between die parts of two units disposed adjacent to each other.

21. A method according to claim 19, characterized in that after the tubular part comprising the locally deformed part has been formed, the die parts in the die are exchanged for die parts that define a larger cavity, whereupon the locally deformed part is positioned in the larger cavity and subsequently a hydraulic pressure is applied, resulting in further deformation of the locally deformed part in the larger cavity, wherein at least two die parts are axially moved toward each other during said further deformation of the locally deformed part.

22. A device suitable for carrying out the method according to claim 15, which device at least comprises a die defining a cavity as well as means for applying a hydraulic pressure to the inside of a tube to be deformed, which is to be positioned in the die, which die comprises at least two die parts being axially movable toward each other, which die parts define a cavity, characterized in that on a first side of the central axis the cavity is bounded by a wall which extends along a relatively small length in axial direction and over a relatively large distance in radial direction, whilst on a second side opposite said first side the cavity is bounded by a wall which extends along a relatively great length in axial direction and over a relatively small distance in radial direction.

23. A device according to claim 22, characterized in that the die parts are provided with recesses and projections extending in axial direction, with projections of one die part being movably accommodated in recesses of the other die part, and conversely.

24. A device according to claim 22, characterized in that the die comprises at least two sets of die parts, which sets are axially movable toward each other, each set comprising at least two die parts which are radially movable toward and away from each other.

25. A device according to claim 22, characterized in that the die comprises a number of units each comprising of two sets of die parts, which sets of die parts of each unit of two sets of die parts are axially movable toward each other.

26. A device according to claim 25, characterized in that the units are axially movable relative to each other.

27. A device according to claim 22, characterized in that the die parts are detachably provided in the die, being exchangeable for die parts that define a larger cavity.

28. A tubular element formed by using the method according to claim 15.
